(19) United States
(12) Patent Application Publication
(10) Pub. No.: US 2024/0157667 A1
(43) Pub. Date: May 16, 2024

(54) Reinforced Honeycomb Core

(71) Applicant: Peter Sing, McCleary, WA (US)

(72) Inventor: Peter Sing, McCleary, WA (US)

(21) Appl. No.: 17/985,007

(22) Filed: Nov. 10, 2022

(51) Int. Cl. B32B 3/12; B32B 7/12; B32B 37/12; B32B 43/00

(52) U.S. Cl. CPC B32B 3/12; B32B 7/12; B32B 37/12; B32B 43/003; B32B 2250/42; B32B 2305/024; B32B 2305/30

(57) ABSTRACT

This invention is designed to improve upon and solve the issues with insulated structural honeycomb core, such as Sing Core US patent #7,147,741, or other honeycomb cores. Sing Core uses a vertical grain veneer to achieve a high compression strength. The issue with vertical grain veneer is that there is no horizontal stability. The reinforced honeycomb structure as described in this patent can use vertical and horizontal grain veneer to have great compression strength and improved horizontal stability. The reinforced honeycomb core is composed of a sheet or multiple sheets of flat building materials adhered to a layer of filler material. The layering will continue in this fashion, alternating between the flat sheet(s) and the filler material(s) to form a large block. While the adhesive is still uncured, the stack of alternating flat building materials and filler materials can be placed in a press. The pressure will allow the adhesive to thoroughly bond across the whole block. Once the adhesive is fully cured, the block can be removed and sliced perpendicular to the flat sheet building materials, through the block. The thickness of the slices off of the block can be, but does not have to be, the same thickness as the filler material. The resulting slices can then be adhered to each other layering the slices to create cellular cavities filled with the filler materials. This can be placed in the press again and left under pressure until fully cured. Once cured the block can be removed from the press and can be sliced parallel to the face showing the cellular filled cavities.

### RELATED APPLICATIONS

This application claims priority under 35 U.S.C. Section 119(e) to U.S. Provisional Application Ser. No. 63/278,918, filed Nov. 12, 2021 entitled “Reinforced Honeycomb Core,” the disclosure of which is incorporated by reference herein in its entirety.

### BACKGROUND OF INVENTION

This invention is designed to solve the issues associated with Sing Core's laminated structural member, U.S. Pat. No. #7,147,741. Sing Core's laminated structural member is a honeycomb designed structure that utilizes vertical grain wood materials along with the filler material. The reinforced honeycomb in this patent can use flat sheet wood products, with single grain direction or multiple grain directions, and/or any flat sheet building materials or any combination of the two. Flat sheet building materials could be any sheet goods such as sheet metals, sheet aluminum, HPL, MDF, wood veneer, plywood, formica, or any other flat sheet building materials.

The reinforced honeycomb core is composed of a sheet or multiple sheets of flat building materials adhered to a layer of filler material. The filler material can be plastic foam, EPS foam, urethane foam, or other filler materials in sheet form. The layering can continue in this fashion, alternating between the flat sheet building materials and sheets of filler material(s) to form a large block. While the adhesive is still uncured, the stack of alternating flat building materials and filler materials can be placed in a press. The pressure will allow the adhesive to thoroughly bond across the whole block. Once the adhesive is fully cured, the block can be removed and sliced perpendicular to the flat sheet building materials, through the block. The thickness of the slices off of the block can be, but does not have to be, the same thickness as the filler material. The resulting slices can then be adhered to each other layering the slices to create cellular cavities filled with the filler materials. This can be placed in the press again and left under pressure until fully cured. Once cured the block can be removed from the press and can be sliced parallel to the face showing the filled cellular cavities.

SUMMARY OF INVENTION

This invention is intended to solve the issues with and improve upon Sing Core's method for making a laminated structural member, U.S. Pat. No. 7,147,741. Sing Core's method for making a laminated structural member utilizes a vertical grain wood veneer reinforced with filler material. The reinforced honeycomb core as described in this patent can use vertical grain wood veneer and/or other flat sheet building materials such as veneer, plywood, HPL, formica, MDF, aluminum, steel, or other flat sheet building materials or any combination of flat sheet building materials.

The reinforced honeycomb core can be composed of a sheet or multiple sheets of flat sheet building materials adhered to a layer of filler material. The filler material can be plastic foam, EPS foam, urethane foam, or other filler materials in sheet form.

The alternating layering, of flat sheet building materials and filler materials with an adhesive between each layer, can continue until the desired size block is created. The block can then be placed into a press to apply pressure until the adhesive is fully cured. Once dry, the newly formed block can be cut into slices that are perpendicular to the flat sheet building material. The resulting slices could then be bonded to each other with an adhesive of choice. The adhesive could be urethane, polyurethane, PVC, PVA, wood glue, or any other type of adhesive. Before the adhesive is applied, the slices can be arranged in a way to create cellular cavities that are filled with the filler material(s).

### SHORT FIGURE DESCRIPTIONS

FIG. 1 is a three dimensional view of a sheet of flat building materials with a horizontal grain

FIG. 2 is a three dimensional view of a sheet of flat building materials with a vertical grain pattern.

FIG. 3 is a three dimensional view of a sheet of flat building materials without any grain direction.

FIG. 4 is a three dimensional view of a sheet of filler materials.

FIG. 5 is a three dimensional view of the resulting block after the first gluing.

FIG. 5A is a three dimensional view of the resulting block after the first gluing with reinforced flat sheet building materials.

FIG. 6 is a three dimensional view of a slice cut from the first gluing block.

FIG. 6A is a three dimensional view of a slice cut from the first gluing block with reinforced flat sheet building materials.

FIG. 7 is a three dimensional view of the resulting block after the second gluing.

FIG. 7A is a three dimensional view of the resulting block after the second gluing with reinforced flat sheet building materials.

FIG. 8 is a three dimensional view of a slice cut from the second gluing block.

FIG. 8A is a three dimensional view of a slice cut from the second gluing block with reinforced flat sheet building materials.

### DESCRIPTION OF PREFERRED EMBODIMENTS

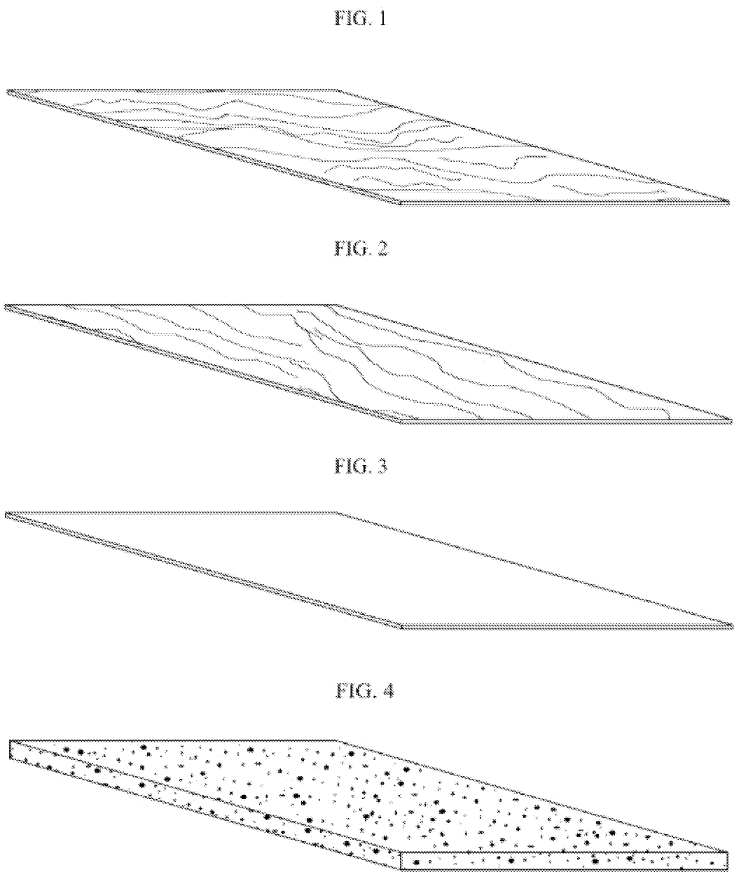

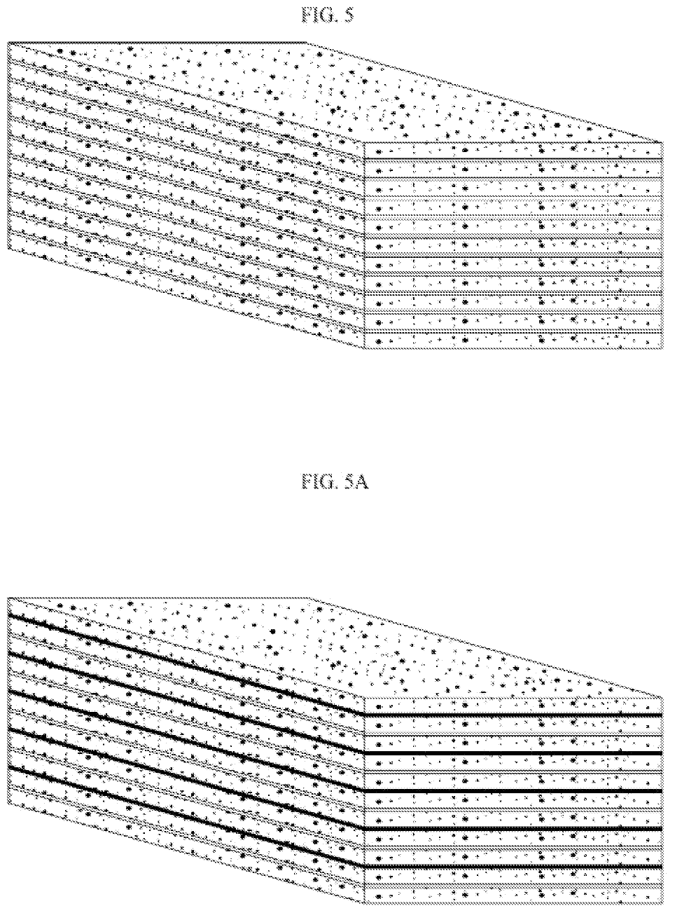

The reinforced honeycomb structure is comprised of flat sheet building materials, which could be vertical or horizontal wood grain products FIG. 1-2, sheet metals, formica, HPL, multi-directional wood grain products, non-grain sheets, or any combination of these materials FIG. 3. Along with the flat sheet building materials, the reinforced honeycomb structure is also comprised of a filler material

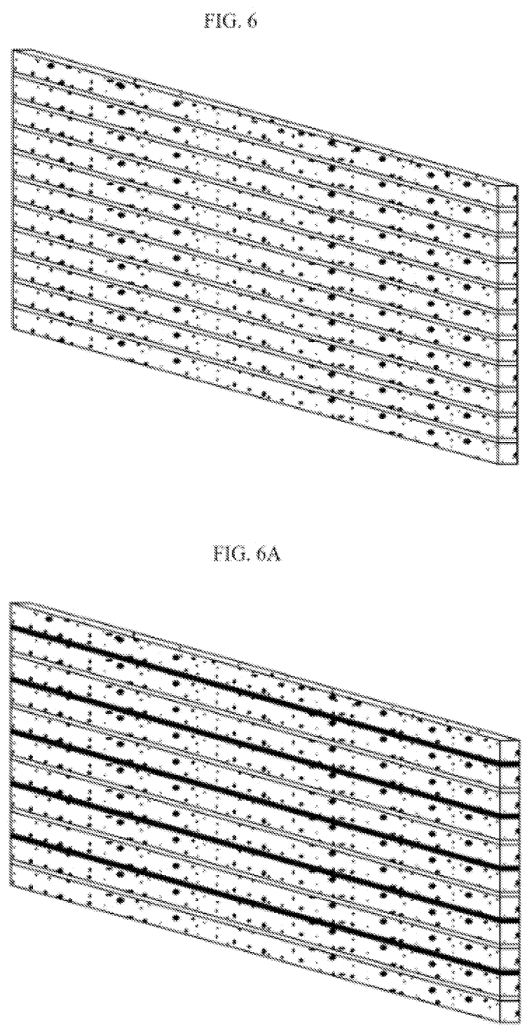

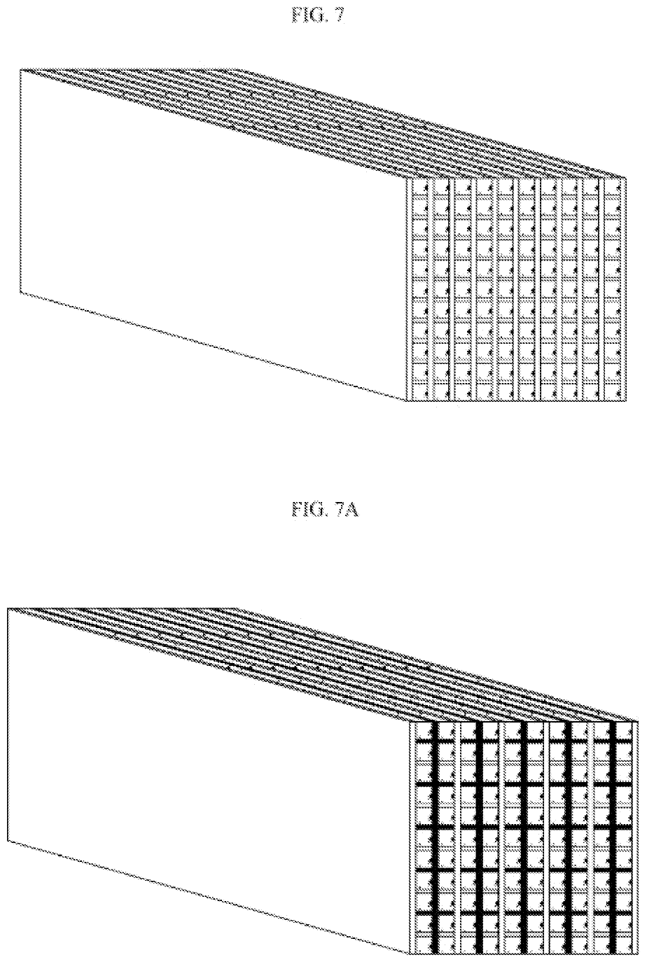

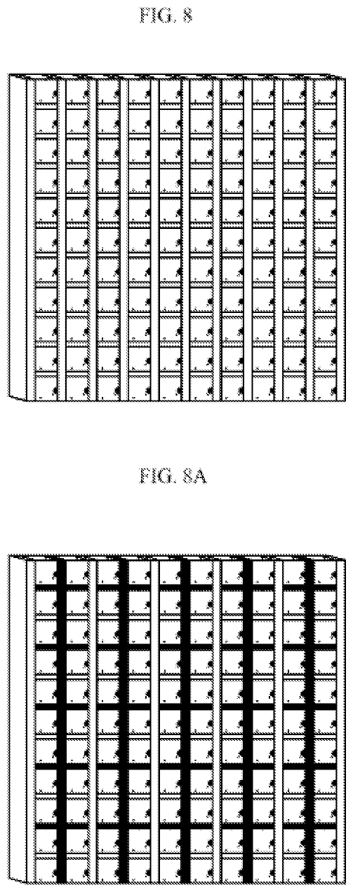

FIG. 4 such as EPS foam, urethane foam, styrofoam, or other filler materials. The flat sheet building materials and filler materials can be adhered to each other in a repeated alternating fashion. After the filler materials and flat sheet building materials are layered with the adhesive, the stack can be placed under pressure using a press. This will ensure a secure bond between each layer. Once fully cured, the resulting block FIG. 5 can be removed from the press and can be sliced perpendicular to the flat sheet building materials. Alternatively, the block can have reinforced flat sheet building materials in place of, or in combination with standard flat sheet building materials FIG. 5A where the black flat sheet building materials are the reinforced flat sheet building materials and the white are the standard flat sheet building materials. The resulting slices FIG. 6 can then be adhered to more flat sheet building materials alternating between each resulting slice from the previously created block. Alternatively the resulting slice may have reinforced flat sheet building material in place of or in combination with the standard flat sheet building materials FIG. 6A. This will form a second block FIG. 7 which can also be placed in a press to cure. Alternatively the second block can have reinforced flat sheet building materials in place of or in combination with the standard flat sheet building materials FIG. 7A. Once the block is fully cured, it can be sliced to a desired thickness and the reinforced honeycomb is ready to use FIG. 8. Alternatively the slice from the second block can have reinforced flat sheet building materials in place of or in combination with the standard flat building materials FIG. 8A.

What is claimed is:

1. The reinforced honeycomb structure can be comprised of flat sheet building materials such as wood veneer, double layered veneer, plywood, HPL, MDF, formica, sheet metals, fiberglass, or other flat sheet building materials and filler materials such as EPS foam, urethane foam, plastic foam or any other filler materials. The filler material and flat sheet building materials can be adhered together with an adhesive of choice, alternating between the two materials to create a block. The block can be placed in a press to allow the adhesive to create a secure bond.

2. In accordance with claim 1, the resulting block can be sliced perpendicular to the flat sheet building materials. The resulting slices can be adhered in layers alternating with flat sheet building materials forming a second block. This block can be placed in a press while the adhesive is curing to ensure a secure bond.

3. In accordance with claim 2, the second block can be removed from the press once fully cured and then can be sliced perpendicular to the flat sheet building materials, creating cellular cavities filled with the filler materials of choice.
